(19) United States
(12) Patent Application Publication
(10) Pub. No.: US 2019/0275970 A1
(43) Pub. Date: Sep. 12, 2019

(54) SURROUNDINGS MONITORING APPARATUS

(71) Applicant: AISIN SEIKI KABUSHIKI KAISHA, Kariya-shi (JP)

(72) Inventors: Wataru SATO, Tsukubamirai-shi (JP); Hiroyuki WATANABE, Chiryu-shi (JP); Jun ADACHI, Okazaki-shi (JP)

(73) Assignee: AISIN SEIKI KABUSHIKI KAISHA, Kariya-shi (JP)

(21) Appl. No.: 16/287,397

(22) Filed: Feb. 27, 2019

(30) Foreign Application Priority Data
Mar. 6, 2018 (JP) 2018-039889

(51) Int. Cl. B60R 21/00; B60R 1/00

(52) U.S. Cl. CPC B60R 21/00; B60R 1/00; B60R 2300/806; B62D 15/027; B60R 2300/102; B60R 2300/607; B60R 2300/303; B60R 2300/202

(57) ABSTRACT

A surroundings monitoring apparatus includes a judgement portion configured to judge an object in a judgement area set in surroundings of a mobile body provided with plural imaging portions. In an overlap area in which imaging areas of the imaging portions overlap each other, a generation portion is configured to set a range of a use area in which captured image is used, and the generation portion is configured to generate surrounding image including the captured image used in the use area, wherein the generation portion changes the range of the use area and generates the surrounding image in accordance with the object.

### CROSS REFERENCE TO RELATED APPLICATIONS

This application is based on and claims priority under 35 U.S.C. § 119 to Japanese Patent Application 2018-039889, filed on Mar. 6, 2018, the entire content of which is incorporated herein by reference.

### TECHNICAL FIELD

This disclosure generally relates to a surroundings monitoring apparatus.

### BACKGROUND DISCUSSION

A known apparatus connects or joins plural captured images captured by plural imaging apparatuses provided at an outer peripheral portion of a mobile body including, for example, a vehicle, and generates image of surroundings of the mobile body. In a region where areas captured respectively by the adjacent imaging apparatuses overlap each other, such a known apparatus generates the image of the surroundings by using the captured image captured by one of the adjacent imaging apparatuses (for example, JP5104171B which will be hereinafter referred to as Patent reference 1).

According to the above-described apparatus, however, there arises a problem that, when an object including a three-dimensional shape such as an obstacle exists in the vicinity of the overlapping areas, the surrounding image is generated in which a blind spot created by the object causes an opposite side of the object falls into the blind spot, and thus other object cannot be observed.

A need thus exists for a surroundings monitoring apparatus which is not susceptible to the drawback mentioned above.

### SUMMARY

According to an aspect of this disclosure, a surroundings monitoring apparatus includes a judgement portion configured to judge an object in a judgement area set in surroundings of a mobile body provided with plural imaging portions each including an imaging area. In an overlap area in which the imaging areas of the imaging portions overlap each other, a generation portion is configured to set a range of a use area in which captured image captured at the imaging portions is used, and the generation portion is configured to generate surrounding image of the mobile body, the surrounding image includes the captured image used in the use area. The generation portion changes the range of the use area and generates the surrounding image in accordance with the object.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plane view of a vehicle on which a surroundings monitoring system of an embodiment disclosed here is configured to be mounted;

FIG. 2 is a block diagram illustrating an overall configuration of the surroundings monitoring system according to the embodiment;

FIG. 3 is a functional block diagram explaining a function of the surroundings monitoring system according to the embodiment;

FIG. 4 is a plane view of surroundings of the vehicle, the view which explains generation of surrounding image in a case where an object does not exist;

FIG. 5 is a plane view of the surroundings of the vehicle, the view which explains the generation of the surrounding image in a case where the object exists;

FIG. 6 is a flowchart of surroundings monitoring processing performed by a processing portion, according to a first embodiment disclosed here;

FIG. 7 is a plane view explaining setting of a range of a use area in a case where the object exists, according to a second embodiment disclosed here;

FIG. 8 is a flowchart of the surroundings monitoring processing performed by the processing portion, according to the second embodiment disclosed here;

FIG. 9 is a plane view explaining the setting of the range of the use area in a case where the object exists, according to a third embodiment disclosed here;

FIG. 10 is a flowchart of the surroundings monitoring processing performed by the processing portion, according to a third embodiment disclosed here;

FIG. 11 is a plane view explaining the setting of the range of the use area in a case where the object exists, according to a fourth embodiment disclosed here; and

FIG. 12 is a side view of a virtual space, the view which explains a method of generating the surrounding image according to a fifth embodiment disclosed here.

### DETAILED DESCRIPTION

In exemplary embodiments described hereunder, similar elements or components are provided with common reference character or reference numeral, and duplicate explanation may be omitted.

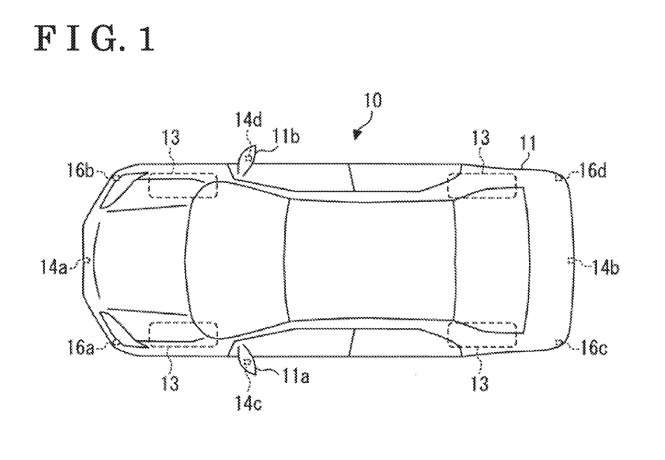

(First embodiment) FIG. 1 is a plane view of a vehicle 10 on which a surroundings monitoring system according to the embodiment disclosed here is configured to be mounted. The vehicle 10 is an example of a mobile body and includes a drive source. For example, the vehicle 10 may be an automobile (an internal combustion engine vehicle) of which a drive source is an internal combustion engine (engine), or may be an automobile (an electric vehicle, a fuel cell vehicle, for example) of which a drive source is an electric motor (motor). For example, the vehicle 10 may be an automobile (a hybrid vehicle) including both the internal combustion engine and the electric motor, as the drive source. The vehicle 10 may be mounted with various kinds of transmission or speed changer, and/or various kinds of apparatus (system, part and component, for example) needed to actuate or drive the internal combustion engine and/or the electric motor. For example, a type, the number and/or a layout of the apparatuses related to the driving of a wheel 13 of the vehicle 10 may be set in various ways.

As illustrated in FIG. 1, the vehicle 10 includes a vehicle body 11, plural wheels 13 (for example, four of the wheels in the embodiment), an imaging portion or plural imaging portions 14a, 14b, 14c, 14d (for example, four of the imaging portions in the embodiment), and a distance measurement portion or plural distance measurement portions 16a, 16b, 16c, 16d (for example, four of the distance measurement portions in the embodiment). When there is no need to distinguish the imaging portions 14a, 14b, 14c, 14d from one another, the imaging portion will be described as the imaging portion 14 or the imaging portions 14. When there is no need to distinguish the distance measurement portions 16a, 16b, 16c, 16d from one another, the distance measurement portion will be described as the distance measurement portion 16 or the distance measurement portions 16.

The vehicle body 11 forms a vehicle cabin for an occupant to be in. The vehicle body 11 accommodates or holds the wheels 13, the imaging portions 14 and the distance measurement portions 16, for example.

The four wheels 13 are provided at the right and left of the front side of the vehicle 10, and at the right and left of the rear side of the vehicle 10, respectively. The two wheels 13 provided at the front side function as steering wheels changing a moving direction of the vehicle 10 in the right and left directions. The two wheels 13 provided at the rear side function as driving wheels driven to rotate by a driving force from a drive source including an engine or motor, for example.

The imaging portion 14 is a digital camera including therein an imaging element such as a Charge Coupled Device (CCD) or a CMOS Image Sensor (CIS), for example. The imaging portion 14 outputs data of moving image including plural frame images generated at a predetermined frame rate, or data of a still image. The imaging portion 14 outputs the above-described data as data of captured image. Each of the imaging portions 14 includes a wide-angle lens or a fisheye lens, and is configured to image or capture a range of 140 degrees to 190 degrees in the horizontal direction. An optical axis of the imaging portion 14 is set obliquely downwards. Accordingly, the imaging portion 14 generates the data of the captured image in which surroundings of the vehicle 10 are captured. The surroundings of the vehicle 10 include an object and a road surface in the surroundings.

Each of the imaging portions 14 is provided at a periphery of the vehicle body 11 and functions as a Multi View Camera (MVC). For example, the imaging portion 14a is provided at a central portion in a right-and-left direction of a front end portion of the vehicle body 11 (for example, a front bumper) so as to face the font side. The imaging portion 14a generates the captured image imaging an area in the front surroundings of the vehicle 10 (which will be hereinafter referred to as an imaging area). The imaging portion 14b is provided at a central portion in the right-and-left direction of a rear end portion (for example, a rear bumper) of the vehicle body 11 so as to face the rear side. The imaging portion 14b generates the captured image imaging the imaging area in the rear surroundings of the vehicle 10. The imaging portion 14c is provided at a central portion in a front-and-rear direction of a left end portion (for example, a side mirror 11a at the left side) of the vehicle body 11 so as to face the left side. The imaging portion 14c generates the captured image of the imaging area in the left surroundings of the vehicle 10. The imaging portion 14d is provided at a central portion in the front-and-rear direction of a right end portion (for example, a side mirror 11b at the right side) of the vehicle body 11 so as to face the right side. The imaging portion 14d generates the captured image imaging the imaging area in the right surroundings of the vehicle 10. The imaging areas, which are captured by the respective imaging portions 14 arranged to be adjacent to each other, are partly overlapped each other. The above-described overlapped area will be referred to as an overlap area.

For example, the distance measurement portion 16 is sonar that outputs detection waves including ultrasonic waves and catches detection waves reflected by an object existing in the surroundings of the vehicle 10. The distance measurement portion 16 may be a laser radar that outputs and catches detection waves including laser beams. The distance measurement portion 16 generates and outputs detection information. The detection information is information related to a direction of an object in the surroundings of the vehicle 10 and a distance to the object. For example, the distance measurement portion 16 detects, as the detection information, the direction of the object existing in the surroundings of the vehicle 10 and a time period from the transmission of the detection waves until the reception of the detection waves reflected by the object (that is, a transmitting-and-receiving time period for calculating the distance to the object). The distance measurement portion 16 is provided at an outer peripheral portion of the vehicle 10, at a position at which the distance measurement portion 16 can detect an object existing in a judgement area which will be described below. For example, the distance measurement portion 16a is provided at a front left portion of the vehicle body 11, and generates and outputs the detection information of the object existing in the judgement area at the front left side of the vehicle 10. The distance measurement portion 16b is provided at a front right portion of the vehicle body 11, and generates and outputs the detection information of the object existing in the judgement area at the front right side of the vehicle 10. The distance measurement portion 16c is provided at a rear left portion of the vehicle body 11, and generates and outputs the detection information of the object existing in the judgement area at the rear left side of the vehicle 10. The distance measurement portion 16d is provided at a rear right portion of the vehicle body 11, and generates and outputs the detection information of the object existing in the judgement area at the rear right side of the vehicle 10.

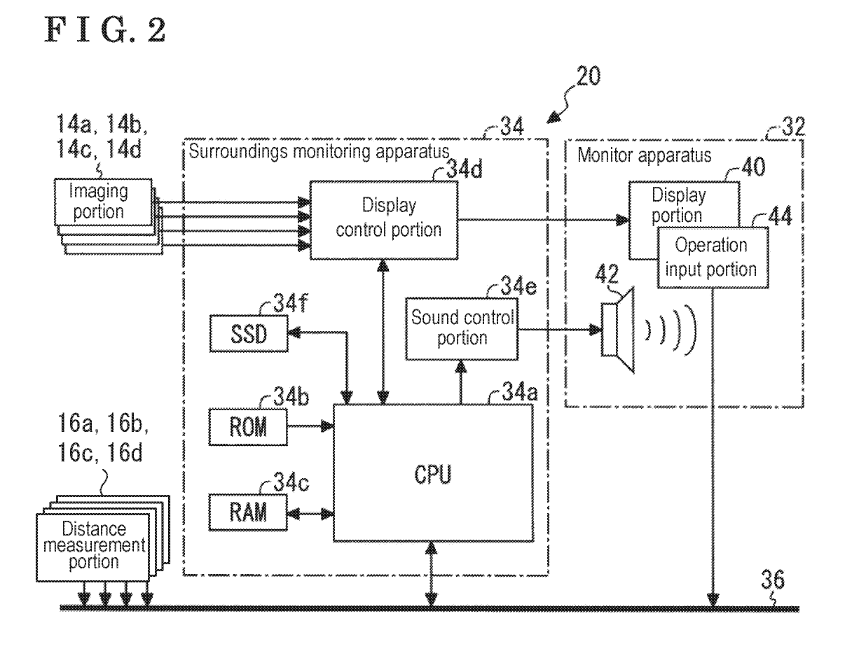

FIG. 2 is a block diagram illustrating an overall configuration of a surroundings monitoring system 20 according to the embodiment. The surroundings monitoring system 20 is mounted on the vehicle 10, and generates and displays surrounding image that is image of the surroundings of the vehicle 10.

As illustrated in FIG. 2, the surroundings monitoring system 20 includes the imaging portions 14, a monitor device 32, a surroundings monitoring apparatus 34 and an in-vehicle network 36.

The imaging portions 14 output the captured image, in which the surroundings of the vehicle 10 are captured, to the surroundings monitoring apparatus 34.

The distance measurement portions 16 output the detection information, which includes the distance to the object existing in the surroundings of the vehicle 10 and the transmitting-and-receiving time period, to the surroundings monitoring apparatus 34 via the in-vehicle network 36.

The monitor device 32 is provided at, for example, a dashboard in the vehicle cabin of the vehicle 10. The monitor device 32 includes a display portion 40, a sound output portion 42 and an operation input portion 44.

The display portion 40 displays image on the basis of image data transmitted by the surroundings monitoring apparatus 34. The display portion 40 is a display apparatus including, for example, a Liquid Crystal Display (LCD) or an Organic Electroluminescent Display (OELD). The display portion 40 displays the surrounding image during a parking maneuver, for example.

The sound output portion 42 outputs sound on the basis of sound data transmitted by the surroundings monitoring apparatus 34. The sound output portion 42 is a loud speaker, for example. The sound output portion 42 outputs sound related to parking assistance, for example.

The operation input portion 44 receives input made or performed by the occupant. The operation input portion 44 is a touch panel, for example. The operation input portion 44 is provided at a display screen of the display portion 40, for example. The operation input portion 44 is configured to be transmissive, that is, to allow the image displayed by the display portion 40 to pass through the operation portion 44. Thus, the operation portion 44 allows the occupant to visually recognize the image displayed on the display screen of the display portion 40. The operation input portion 44 receives instruction related to the surroundings monitoring and transmits the instruction to the surroundings monitoring apparatus 34. The instruction is inputted by the occupant who touches a position corresponding to the image displayed on the display screen of the display portion 40. The operation input portion 44 is not limited to the touch panel and may be a hardware button of a push-button type, for example.

The surroundings monitoring apparatus 34 is a computer including a microcomputer including, for example, an Electronic Control Unit (ECU). The surroundings monitoring apparatus 34 acquires the data of the plural captured images taken by the plural imaging portions 14. The surroundings monitoring apparatus 34 generates, from the plural captured images, the surrounding image that is the image of the surroundings of the vehicle 10, and then causes the generated image to be displayed at the display portion 40 of the surroundings monitoring apparatus 34. The surroundings monitoring apparatus 34 transmits data to the monitor device 32, the data which is related to instructions to a driver and image or sound including a notification to the driver.

The surroundings monitoring apparatus 34 includes a CPU (Central Processing Unit) 34a, an ROM (Read Only Memory) 34b, an RAM (Random Access Memory) 34c, a display control portion 34d, a sound control portion 34e and an SSD (Solid State Drive) 34f. The CPU 34a, the ROM 34b and the RAM 34c may be integrated in the same package.

The CPU 34a is an example of a hardware processor. The CPU 34a reads program stored in a nonvolatile storage including the ROM 34b and performs various arithmetic processing and control in accordance with the program. For example, the CPU 34a performs surroundings monitoring processing in which the surrounding image is generated.

The ROM 34b stores parameter needed to for each program and for execution of the program, for example. The RAM 34c temporarily stores various data used for the arithmetic processing at the CPU 34a. Out of the arithmetic processing performed at the surroundings monitoring apparatus 34, the display control portion 34d mainly executes image processing of the image obtained at the imaging portion 14 and performs data conversion of the image to be displayed at the display portion 40, for example. Out of the arithmetic processing performed at the surroundings monitoring apparatus 34, the sound control portion 34e mainly performs processing of the sound to be outputted to the sound output portion 42, for example. The SSD 34f is a rewritable nonvolatile storage and maintains data even in a case where a power switch of the surroundings monitoring apparatus 34 is turned off.

The in-vehicle network 36 connects the distance measurement portions 16, the operation input portion 44 of the monitor device 32 and the surroundings monitoring apparatus 34 to one another such that the distance measurement portions 16, the operation input portion 44 and the surroundings monitoring apparatus 34 can send and receive the information with one another.

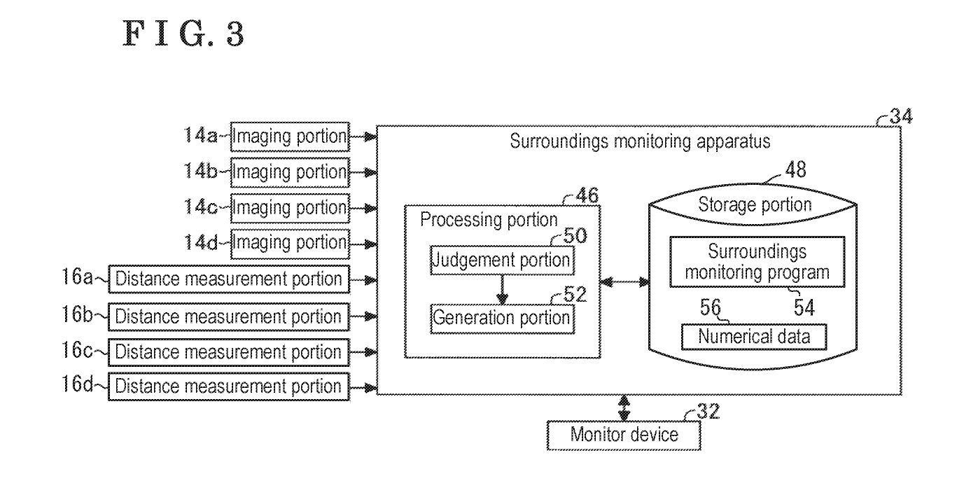

FIG. 3 is a functional block diagram explaining a function of the surroundings monitoring system 34. As illustrated in FIG. 3, the surroundings monitoring system 34 includes a processing portion 46 and a storage portion 48.

The processing portion 46 is implemented as the functions of the CPU 34a and the display control portion 34d. The processing portion 46 functions as a judgement portion 50 and a generation portion 52. For example, the processing portion 46 reads surroundings monitoring program 54 stored in the storage portion 48, and thus functions as the judgement portion 50 and the generation portion 52. A part or all of the judgement portion 50 and the generation portion 52 may be configured by a circuit including an Application Specific Integrated Circuit (ASIC) and a Field-Programmable Gate Array (FPGA), for example.

The judgement portion 50 judges the object in the judgement area in the surroundings of the vehicle 10. Specifically, the judgement portion 50 sets an area, in which whether or not a blind spot occurs in the overlap area due to the object is able to be judged, as the judgement area. For example, the judgement area set by the judgement portion 50 includes the overlap area in which the imaging areas of the respective imaging portions 14 overlap each other. The judgement area also includes areas formed between the overlap area and the respective imaging portions 14. Positions of the overlap area and the judgement area, relative to the vehicle 10, may be stored in the storage portion 48 as overlap area information and judgement area information in advance. The judgement portion 50 calculates a distance to an object including a three-dimensional shape in the surroundings of the vehicle 10 on the basis of the detection information acquired from the distance measurement portion 16. The judgement portion 50 identifies the position of the object on the basis of the direction of the object indicated by the detection information and the calculated distance. The judgement portion 50 judges whether or not the object exists in the judgment area. When the judgement portion 50 judges that the object exists in the judgement area, the judgement portion 50 outputs, to the generation portion 52, judgement information including the existence of the object and identification information for identifying the judgement area in which the object exists.

The generation portion 52 generates the surrounding image that is the image of the surroundings of the vehicle 10 from the plural images respectively obtained from the plural imaging portions 14, and the generation portion 52 causes the generated image to be displayed at the display portion 40. The plural images mentioned here include the images captured by the imaging portions 14, and processed image obtained by performing, on the captured image, processing of eliminating distortion and image processing of changing a viewpoint with the use of mapping data, for example. The surrounding image may be overhead image viewing the surroundings of the vehicle 10 from a virtual view point set above the vehicle 10, for example. The generation portion 52 may generate the surrounding image including the entire circumference (that is, 360 degrees) of the surroundings of the vehicle 10 or the generation portion 52 may generate the surrounding image including part of the surroundings of the vehicle 10. Out of the plural imaging portions 14, the imaging areas of the imaging portions 14 which are adjacent to each other include the overlap area in which the imaging areas overlap each other. When generating the surrounding image, the generation portion 52 sets a range of a use area for using or employing one of the captured images in the overlap area in such a manner that the range of the use areas do not overlap with each other. The generation portion 52 generates the surrounding image with the use of the plural captured images including the captured image within the range of the use area that has been set.

Here, the generation portion 52 changes the range of the use area in accordance with the object indicated by the judgement information acquired from the judgement portion 50 that has judged the existence of the object, and generates the surrounding image. For example, the generation portion 52 sets a range of a first use area in the overlap area in a case where the object does not exist in the judgement area and the generation portion 52 sets a range of a second use area in the overlap area in a case where the object exists in the judgement area. The range of the first use area and the range of the second use area may be stored in the storage portion 48 as predetermined use area information.

The storage portion 48 is implemented as the functions of the ROM 34b, the RAM 34c and the SSD34f. The storage portion 48 may be an external storage connected via network, for example. The storage portion 48 stores the program executed by the processing portion 46, data required for the execution of the program and data generated due to the execution of the program, for example. For example, the storage portion 48 stores the surroundings monitoring program 54 that the processing portion 46 executes. For example, the surroundings monitoring program 54 may be stored in storage media that can be read by computer, including Compact Disc Read Only Memory (CD-ROM) or Digital Versatile Disc Read Only Memory (DVD-ROM), and then be provided. Or the surroundings monitoring program 54 may be provided via network including the internet, for example. The storage portion 48 stores therein numerical data 56 including, for example, the overlap area information and the use area information which are needed for the execution of the surroundings monitoring program 54. The storage portion 48 temporarily stores the information which includes the surrounding image generated due to the execution of the surroundings monitoring program 54 and the judgement information of the judgement portion 50.

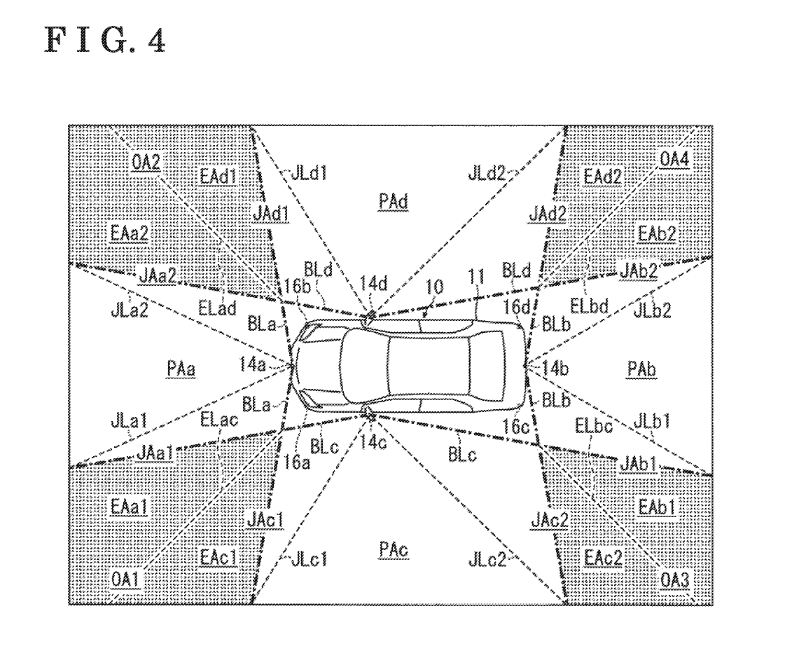

FIG. 4 is a plane view of the surroundings of the vehicle 10 for explaining the generation of the surrounding image in a case where the object does not exist. The outer frame of FIG. 4 corresponds to a range which is generated as the surrounding image. In the explanation below, in a case where the imaging areas do not need to be distinguished from each other, the imaging area will be referred to as an imaging area PA in a manner that part of the reference character is omitted. In a similar manner, the overlap area will be referred to as an overlap area OA, the judgement area will be referred to as a judgement area JA, the use area will be referred to as a use area EA, the respective boundary lines will be referred to as a judgement boundary line JL, a boundary line BL and a use boundary line EL, for example.

The imaging area of each of the imaging portions 14 will be described.

The imaging portion 14a captures or images within an imaging area PAa which is at the front side relative to a boundary line BLa indicated by a dash-dot line. The imaging portion 14b captures or images within an imaging area PAb which is at the rear side relative to a boundary line BLb indicated by another dash-dot line. The imaging portion 14c captures or images within an imaging area PAc which is at the left side relative to a boundary line BLc indicated by another dash-dot line. The imaging portion 14d captures or images within an imaging area PAd which is at the right side relative to a boundary line BLd indicated by another dash-dot line.

The imaging area PAa and the imaging area PAc include an overlap area OA1 in which the imaging area PAa and the imaging area PAc overlap each other as illustrated by dot-hatching in the drawings. The overlap area OA1 is positioned at the front left side of the vehicle 10. The imaging area PAa and the imaging area PAd include an overlap area OA2 in which the imaging area PAa and the imaging area PAd overlap each other as illustrated by dot-hatching in the drawings. The overlap area OA2 is positioned at the front right side of the vehicle 10. The imaging area PAb and the imaging area PAc include an overlap area OA3 in which the imaging area PAb and the imaging area PAc overlap each other as illustrated by dot-hatching in the drawings. The overlap area OA3 is positioned at the rear left side of the vehicle 10. The imaging area PAb and the imaging area PAd include an overlap area OA4 in which the imaging area PAb and the imaging area PAd overlap each other as illustrated by dot-hatching in the drawings. The overlap area OA4 is positioned at the rear right side of the vehicle 10.

Next, the judgement area will be described.

The judgement portion 50 sets judgement areas JAa1 and JAa2 for judging whether or not the blind spot occurs to the imaging portion 14a due to the object including a three-dimensional shape. The judgement portion 50 sets the judgement area JAa1 at an area between a judgement boundary line JLa1 indicated by a dashed line and the boundary line BLa at the left side relative to the imaging portion 14a. The judgement portion 50 sets the judgement area JAa2 at an area between a judgement boundary line JLa2 indicated by another dashed line and the boundary line BLa at the right side relative to the imaging portion 14a. The judgement boundary lines JLa1 and JLa2 may be boundary lines set according to a predetermined condition. For example, the judgement portion 50 may set one end of each of the judgement boundary lines JLa1 and JLa2 at the imaging portion 14a, and set the other end of each of the judgement boundary lines JLa1 and JLa2 at respective positions at which the boundary lines BLc and BLd at the front side intersect the outer frame of the range of the surrounding image. Accordingly, the judgement portion 50 may change the judgement areas JAa1 and/or JAa2 when the range of the surrounding image is changed due to enlargement or reduction.

The judgement portion 50 sets judgement areas JAb1 and JAb2 for judging whether or not the blind spot occurs to the imaging portion 14b. The judgement portion 50 sets the judgement area JAb1 at an area between a judgement boundary line JLb1 indicated by a dashed line and the boundary line BLb at the left side relative to the imaging portion 14b. The judgement portion 50 sets the judgement area JAb2 at an area between a judgement boundary line JLb2 indicated by another dashed line and the boundary line BLb at the right side relative to the imaging portion 14b. The judgement boundary lines JLb1 and JLb2 may be boundary lines set according to a predetermined condition. For example, the judgement portion 50 may set one end of each of the judgement boundary lines JLb1 and JLb2 at the imaging portion 14b, and set the other end of each of the judgement boundary lines JLb1 and JLb2 at respective positions at which the boundary lines BLc and BLd at the rear side intersect the outer frame of the range of the surrounding image. Accordingly, the judgement portion 50 may change the judgement areas JAb1 and/or JAb2 when the range of the surrounding image is changed due to enlargement or reduction.

The judgement portion 50 sets judgement areas JAc1 and JAc2 for judging whether or not the blind spot occurs to the imaging portion 14c. The judgement portion 50 sets the judgement area JAc1 at an area between a judgement boundary line JLc1 indicated by a dashed line and the boundary line BLc at the front side relative to the imaging portion 14c. The judgement portion 50 sets the judgement area JAc2 at an area between a judgement boundary line JLc2 indicated by another dashed line and the boundary line BLc at the rear side relative to the imaging portion 14c. The judgement boundary lines JLc1 and JLc2 may be boundary lines set according to a predetermined condition. For example, the judgement portion 50 may set one end of each of the judgement boundary lines JLc1 and JLc2 at the imaging portion 14c, and set the other end of each of the judgement boundary lines JLc1 and JLc2 at respective positions at which the boundary lines BLa and BLb at the left side intersect the outer frame of the range of the surrounding image. Accordingly, the judgement portion 50 may change the judgement areas JAc1 and/or JAc2 when the range of the surrounding image is changed due to enlargement or reduction.

The judgement portion 50 sets judgement areas JAd1 and JAd2 for judging whether or not the blind spot occurs to the imaging portion 14d. The judgement portion 50 sets the judgement area JAd1 at an area between a judgement boundary line JLd1 indicated by a dashed line and the boundary line BLd at the front side relative to the imaging portion 14d. The judgement portion 50 sets the judgement area JAd2 at an area between a judgement boundary line JLd2 indicated by another dashed line and the boundary line BLd at the rear side relative to the imaging portion 14d. The judgement boundary lines JLd1 and JLd2 may be boundary lines set according to a predetermined condition. For example, the judgement portion 50 may set one end of each of the judgement boundary lines JLd1 and JLd2 at the imaging portion 14d, and set the other end of each of the judgement boundary lines JLd1 and JLd2 at respective positions at which the boundary lines BLa and BLb at the right side intersect the outer frame of the range of the surrounding image. Accordingly, the judgement portion 50 may change the judgement areas JAd1 and/or JAd2 when the range of the surrounding image is changed due to enlargement or reduction.

In other words, the judgement portion 50 sets the two judgement areas JA for each of one imaging portion 14 and another imaging portion 14 which shares the overlap area OA with the one imaging portion 14. The judgement portion 50 sets each judgment area JA at the area between the judgement boundary line JL of which one end is the one imaging portion 14 and of which the other end is the position at which the boundary line BL of said another imaging portion 14 intersect the outer frame of the surrounding image, and the boundary line BL of the imaging area PA of the one imaging portions 14.

Next, the range of the predetermined first use area in a case where the object does not exist in the judgement areas JAa1 to JAd2 will be described.

A portion of the overlap area OA1, the portion which is located at a side of a center line of the imaging area PAa (that is, the portion located at an optical axis side of the imaging portion 14a) relative to a use boundary line ELac indicated by a dashed line, corresponds to a range of a first use area EAa1 in which the captured image taken by the imaging portion 14a is used. Another portion of the overlap area OA1, the portion which is located at a side of a center line of the imaging area PAc (that is, at an optical axis side of the imaging portion 14c) relative to the use boundary line ELac indicated by the dashed line, corresponds to a range of a first use area EAc1 in which the captured image taken by the imaging portion 14c is used. For example, the use boundary line ELac may be a line which passes through the intersection point of the boundary lines BLa and BLc, and which is in a direction bisecting a crossing angle formed, at a side of the overlap area OA1, by the boundary lines BLa and BLc surrounding the overlap area OA1.

A portion of the overlap area OA2, the portion which is located at a side of the center line of the imaging area PAa relative to a use boundary line ELad indicated by a dashed line, corresponds to a range of a first use area EAa2 in which the captured image taken by the imaging portion 14a is used. Another portion of the overlap area OA2, the portion which is located at a side of a center line of the imaging area PAd (that is, at an optical axis side of the imaging portion 14d) relative to the use boundary line ELad indicated by the dashed line, corresponds to a range of a first use area EAd1 in which the captured image taken by the imaging portion 14d is used. For example, the use boundary line ELad may be a line which passes through the intersection point of the boundary lines BLa and BLd, and which is in a direction bisecting a crossing angle formed, at a side of the overlap area OA2, by the boundary lines BLa and BLd surrounding the overlap area OA2.

A portion of the overlap area OA3, the portion which is located at a side of a center line of the imaging area PAb (that is, at an optical axis side of the imaging portion 14b) relative to a use boundary line ELbc indicated by a dashed line, corresponds to a range of a first use area EAb1 in which the captured image taken by the imaging portion 14b is used. Another portion of the overlap area OA3, the portion which is located at a side of the center line of the imaging area PAc relative to the use boundary line ELbc indicated by the dashed line, corresponds to a range of a first use area EAc2 in which the captured image taken by the imaging portion 14c is used. For example, the use boundary line ELbc may be a line which passes through the intersection point of the boundary lines BLb and BLc, and which is in a direction bisecting a crossing angle formed, at a side of the overlap area OA3, by the boundary lines BLb and BLc surrounding the overlap area OA3.

A portion of the overlap area OA4, the portion which is located at a side of the center line of the imaging area PAb relative to a use boundary line ELbd indicated by a dashed line, corresponds to a range of a first use area EAb2 in which the captured image taken by the imaging portion 14b is used. Another portion of the overlap area OA4, the portion which is located at a side of the center line of the imaging area PAd relative to the use boundary line ELbd indicated by the dashed line, corresponds to a range of a first use area EAd2 in which the captured image taken by the imaging portion 14d is used. For example, the use boundary line ELbd may be a line which passes through the intersection point of the boundary lines BLb and BLd, and which is in a direction bisecting a crossing angle formed, at a side of the overlap area OA4, by the boundary lines BLb and BLd surrounding the overlap area OA4.

In other words, a region of the overlap area OA, the region which is at a side of one imaging portion 14 relative to the use boundary line EL, corresponds to a range of a first use area EA of the one imaging portion 14. Another region of the overlap area OA, the region which is at a side of another imaging portion 14 (imaging portion 14 that shares the overlap area OA with the one imaging portion 14) relative to the use boundary line EL, corresponds to a range of a first use area EA of said another imaging portion 14. Here, the use boundary line EL is the line which passes through the intersection point of the boundary lines BL of the overlap area OA and which is in the direction bisecting the crossing angle formed at a side of the overlap area OA.

In a case where the object does not exist in the judgement areas JAa1 to JAd2, the generation portion 52 generates the surrounding image by using or employing the captured image imaging the range of the first use areas EAa1 to EAd2 as described above. Thus, the generation portion 52 uses the captured image imaging the ranges of the first use areas EAa1 and EAa2 which are taken by the imaging portion 14a, together with the captured image other than the overlap area OA1. The generation portion 52 uses the captured image imaging the ranges of the first use areas EAb1 and EAb2 which are taken by the imaging portion 14b, together with the captured image other than the overlap area OA2. The generation portion 52 uses the captured image imaging the ranges of the first use areas EAc1 and EAc2 which are taken by the imaging portion 14c, together with the captured image other than the overlap area OA3. The generation portion 52 uses the captured image imaging the ranges of the first use areas EAd1 and EAd2 which are taken by the imaging portion 14d, together with the captured image other than the overlap area OA4. The generation portion 52 generates the surrounding image by synthesizing the captured images used or employed as described above, in a manner that the captured images are joined or connected to each other at the use boundary lines ELac, ELad, ELbc and ELbd. In other words, the generation portion 52 does not use, for generating the surrounding image, the captured image imaging the ranges of the first use areas EAc1 and EAd1 which are taken by the imaging portion 14a. The generation portion 52 does not use, for generating the surrounding image, the captured image imaging the ranges of the first use areas EAc2 and EAd2 which are taken by the imaging portion 14b. The generation portion 52 does not use, for generating the surrounding image, the captured image imaging the ranges of the first use areas EAa1 and EAb1 which are taken by the imaging portion 14c. The generation portion 52 does not use, for generating the surrounding image, the captured image imaging the ranges of the first use areas EAa2 and EAb2 which are taken by the imaging portion 14d.

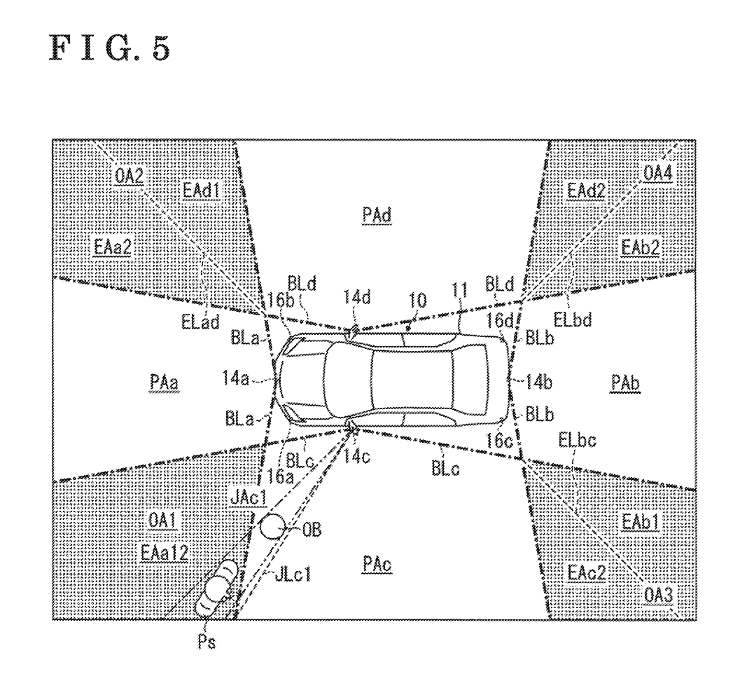

FIG. 5 is a plane view of the surroundings of the vehicle 10 for explaining the generation of the surrounding image in a case where the object exists. In FIG. 5, the reference characters which are not necessary for the explanation are partly omitted.

In the circumstances illustrated in FIG. 5, the judgement portion 50 judges that an object OB including a three-dimensional shape exists in the judgement area JAc1. For example, the object OB is a utility pole extended in the vertical direction from the ground surface. The judgement portion 50 outputs, to the generation portion 52, the judgement information including the existence of the object OB and the information that identifies the judgement area JAc1 in which the object OB exists, as the judgement information. When the object OB is present in the judgement area JAc1, the blind spot occurs in the overlap area OA1 of the imaging portion 14c which is included in the judgement area JAc1. Therefore, the imaging portion 14c is not able to capture image of an object including, for example, a person Ps, existing in the blind spot. On the other hand, the imaging portion 14a sharing the overlap area OA1 with the imaging portion 14c is able to capture the image of the person Ps because the blind spot is not generated to the imaging portion 14a.

When the generation portion 52 acquires the judgement information from the judgement portion 50, the generation portion 52 changes the range of the use area from the range of the first use areas EAa1 and EAc1 to a range of a second use area EAa12. For example, in the overlap area OA1 where the blind spot occurs, the generation portion 52 increases the range of the use area in which the captured image of the imaging portion 14a is used and reduces the range of the use area in which the captured image of the imaging portion 14c is used. Specifically, the generation portion 52 increases or extends the range of the second use area EAa12 that employs the captured image taken by the imaging portion 14a to the whole of the overlap area OA1, and eliminates the area that employs the captured image taken by the imaging portion 14c.

The generation portion 52 generates the surrounding image in accordance with the range of the use area EA. In the overlap area OA in which the blind spot does not occur because the object OB does not exists in the judgement area JA, the generation portion 52 uses the captured image of the range of the first use area EA to generate the surrounding image.

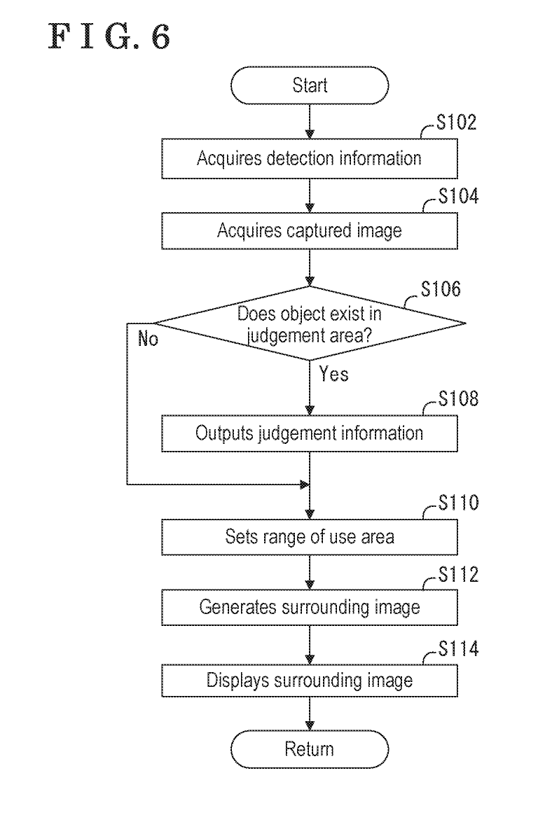

FIG. 6 is a flowchart of the surroundings monitoring processing performed by the processing portion 46 according to the first embodiment. The processing portion 46 executes the surroundings monitoring processing by reading out the surroundings monitoring program 54.

As illustrated in FIG. 6, in the surroundings monitoring processing, the judgement portion 50 acquires the detection information from each of the distance measurement portions 16 (S102). The generation portion 52 acquires the captured image from each of the imaging portions 14 (S104).

The judgement portion 50 judges on the basis of the acquired detection information whether or not the object OB exists in any of the judgement areas JA (S106). If the judgement portion 50 judges that the object OB exists in the judgement area JA (S106: Yes), the judgement portion 50 outputs the judgement information including the existence of the object OB in the judgement area JA and the information identifying the judgement area JA, to the generation portion 52 (S108). If the judgement portion 50 judges that the object OB does not exist in the judgement area JA (S106: No), the judgement portion 50 does not output the judgement information.

The generation portion 52 sets, in each of the overlap areas OA, the range of the use area EA (S110). For example, in a case where the generation portion 52 has not acquired the judgement information, the generation portion 52 sets, in each of the overlap areas OA, the range of the first use area EA formed by dividing the overlap area OA equally into two. In contrast, in a case where the generation portion 52 has acquired the judgement information informing that the object OB exists in the judgement area JA, the generation portion 52 sets, in the overlap area OA included in the judgement area in which the object OB exists, the range of the second use area EA. Specifically, the generation portion 52 sets the range of the second use area EA using or employing the captured image of the imaging portion 14 whose judgement area JA does not include the object OB, over an entire area of the overlap area OA.

The generation portion 52 generates the surrounding image in accordance with the range of the use area EA that is set (S112). Specifically, in the overlap area OA, the generation portion 52 employs the captured image of the range of the use area EA. In other area than the overlap area OA, the generation portion 52 employs the image that exists. The generation portion 52 synthesizes and joins the employed images to each other, thereby generating the surrounding image. The generation portion 52 outputs the generated surrounding image to the display portion 40 so that the surrounding image are displayed (S114).

As stated above, at the surroundings monitoring apparatus 34 according to the first embodiment, it is judged whether or not the object OB causing the blind spot exists in the judgement area JA. Then, in accordance with the object OB, the range of the use area EA for using either of the captured images overlapping in the overlap area OA is set. Thus, in the overlap area OA, by employing the captured image including less blind spot, the surroundings monitoring apparatus 34 can provide the surrounding image in which the blind spot is reduced.

The surroundings monitoring apparatus 34 sets the range of the predetermined first use area EA in the overlap area OA in a case where the object OB does not exist in the judgement area JA and the surroundings monitoring apparatus 34 sets the range of the predetermined second use area EA in a case where the object OB exists in the judgement area JA. By setting either the range of the first use area EA or the range of the second use area EA, which are determined in advance, the surroundings monitoring apparatus 34 can provide the surrounding image including less blind spot, while a burden of processing needed to set the range of the use area EA is reduced.

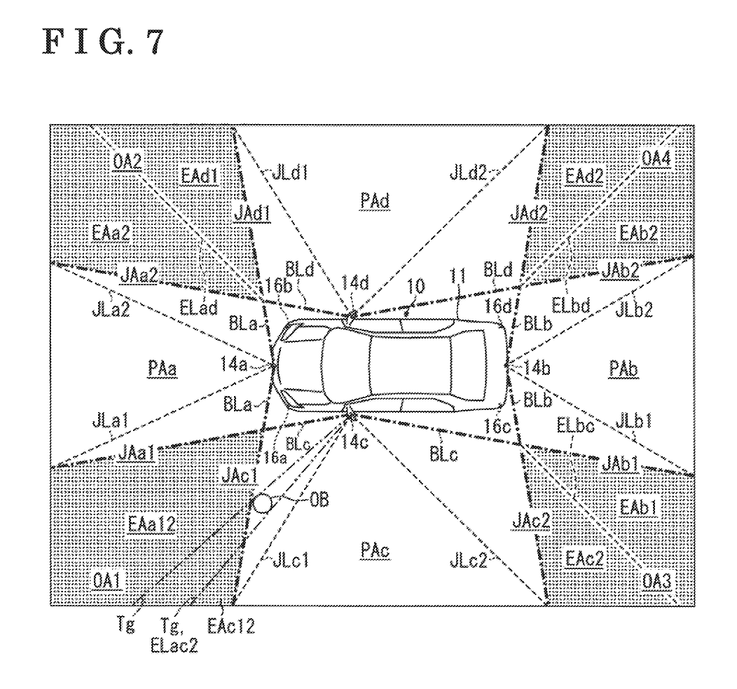

(Second embodiment) The surroundings monitoring apparatus 34 according to a second embodiment sets the range of the use area EA in accordance with a position of the object OB in the judgement area JA. Configurations of the surroundings monitoring apparatus 34 of the second embodiment will be described below specifically. Each configuration of the second embodiment is same as each configuration of the first embodiment except for functions, therefore the same reference characters as the first embodiment will be used in the explanation. FIG. 7 is a plane view explaining setting of the range of the use area EA according to the second embodiment, in a case where the object exists.

The judgement portion 50 acquires the detection information from the distance measurement portion 16. The judgement portion 50 calculates the distance to the object OB on the basis of the transmitting-and-receiving time period indicated by the detection information. The judgement portion 50 calculates the position of the object OB on the basis of the direction of the object OB which is indicated by the detection information and the calculated distance. For example, the judgement portion 50 may calculate a position of an outline of the object OB and identify a shape and configuration of the object OB together with the position of the object OB. The judgement portion 50 outputs the position of the outline of the object OB to the generation portion 52.

In a case where the object OB does not exist in the judgment area JA and thus the generation portion 52 does not acquire the judgement information, the generation portion 52 sets the range of the use area which is similar to the range of the first use area of the first embodiment.

In a case where the object OB exists in the judgment area JA and thus the generation portion 52 acquires the judgement information indicating the position of the object OB, the generation portion 52 sets the range of the use area EA that is in accordance with the position of the object OB and generates the surrounding image. Specifically, the generation portion 52 generates the surrounding image as follows. Each line that passes through the imaging portion 14 and is in contact with the outline of the object OB, and serves as a boundary of the blind spot is referred to as a tangent Tg. Out of the tangents Tg, the generation portion 52 calculates the tangent Tg which is located at a side of or nearer to the center line of the imaging area PAc (that is, the tangent Tg which is located at an optical axis side of the imaging portion 14c), as a use boundary line ELac2 of the use area EA. As indicated by the two-dot chain line in FIG. 7, the tangent Tg mentioned here is a line that passes through the imaging portion 14 for which the judgement area JA includes the object OB, that is in contact with the outline of the object OB at one point, and that does not intersect the outline of the object OB, when seen in a plane view. The generation portion 52 sets, with the use of the calculated use boundary line ELac2, the ranges of the use areas EA in the overlap area OA1 in which the blind spot exists. Specifically, the generation portion 52 sets a portion of the overlap area OA which is located at a side of the imaging portion 14a including no blind spot relative to the use boundary line ELac2 as the range of the use area EAa12 where the captured image taken by the imaging portion 14a is used. The generation portion 52 sets another portion of the overlap area OA which is located at a side of the imaging portion 14c including the blind spot relative to the use boundary line ELac2 as the range of a use area EAc12 where the captured image taken by the imaging portion 14c is used. Thus, in the area in which the blind spot occurs to the imaging portion 14c due to the object OB, the generation portion 52 uses or employs the captured image taken by the imaging portion 14a.

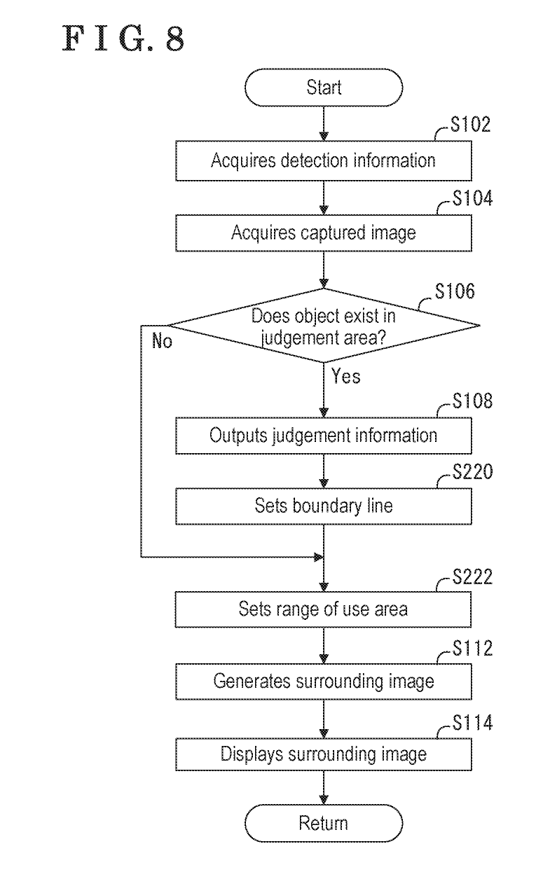

FIG. 8 is a flowchart of the surroundings monitoring processing according to the second embodiment performed by the processing portion 46. In the explanation of the second embodiment, the steps similar to the first embodiment will be explained in a simplified manner.

As illustrated in FIG. 8, according to the surroundings monitoring processing of the second embodiment, the judgement portion 50 acquires the detection information (S102). The generation portion 52 acquires the captured image (S104). The judgement portion 50 judges whether or not the object OB exists in the judgement area JA (S106). If the judgement portion 50 judges that the object OB exists in the judgement area JA (S106: Yes), the judgement portion 50 outputs the judgement information that indicates the existence of object OB and the position of the object OB (S108).

The generation portion 52 sets the use boundary line EL for setting the range of the use area EA, on the basis of the position of the object OB indicated by the judgement information acquired from the judgement portion 50 (S220). Specifically, out of the tangents Tg that pass the imaging portion 14 whose judgement area JA includes the object OB and that are in contact with the outline of the object OB, the generation portion 52 sets, as the use boundary EL, the tangent Tg which is positioned at a side of the center line of the imaging area PA of the imaging portion 14 (that is, the tangent Tg which is positioned nearer to the center line of the imaging area PA of the imaging portion 14).

The generation portion 52 sets the range of the use area EA (S222). Specifically, in the overlap area OA in which the object OB does not exists in the judgement area JA, the generation portion 52 sets the range of the use area EA in such a manner that each overlap area OA is bisected similarly to the range of the first use area EA of the first embodiment. In contrast, in the overlap area OA where the blind spot is generated due to the object OB existing in the judgement area JA, the generation portion 52 sets a portion of the overlap area OA, the portion which is located at a side of the center line of the imaging area PA of the imaging portion 14 to which the blind spot is generated, relative to the use boundary line EL, as the range of the use area EA of the said imaging portion 14. And in the overlap area OA where the blind spot is generated due to the object OB existing in the judgement area JA, the generation portion 52 sets another portion of the overlap area OA, the portion which is located at a side of the center line of the imaging area PA of the imaging portion 14 to which the blind spot is not generated, relative to the use boundary line EL, as the range of the use area EA of the said imaging portion 14.

The generation portion 52 generates the surrounding image on the basis of the range of the use area EA that has been set (S112). The generation portion 52 causes the generated surrounding image to be displayed at the display portion 40 (S114).

As stated above, the surroundings monitoring apparatus 34 of the second embodiment sets the range of the use area EA in accordance with the position of the object OB existing within the judgement area JA. Thus, out of the captured images, the surroundings monitoring apparatus 34 can reduce the use or employment of the captured image of the vicinity of an outer edge portion of the image area PA in which an image distortion is large. As a result, the surroundings monitoring apparatus 34 can provide the surrounding image with a high image quality, while reducing the blind spot.

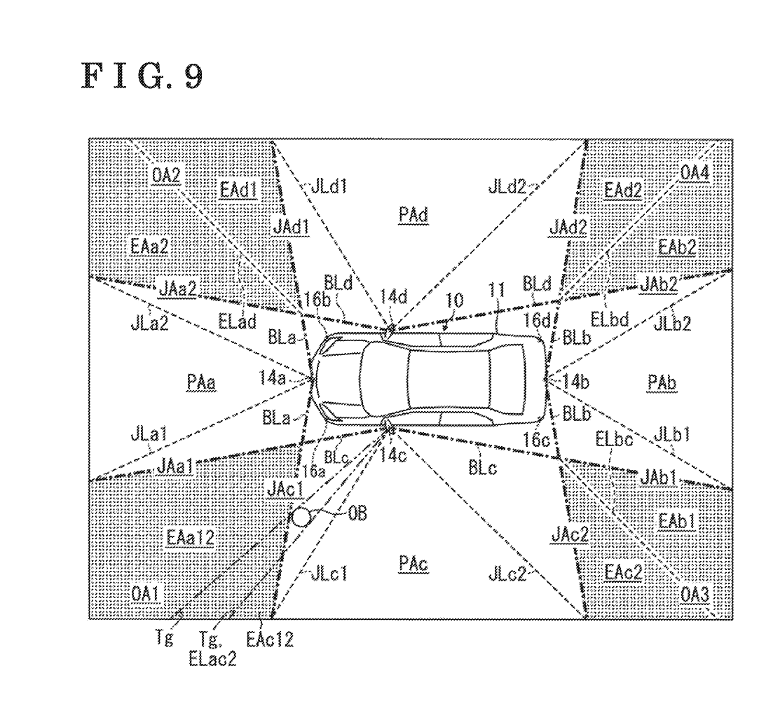

(Third embodiment) The surroundings monitoring apparatus 34 according to a third embodiment calculates the blind spot of the imaging portion 14 and sets the range of the use area EA. Configurations of the surroundings monitoring apparatus 34 according to the third embodiment will be described below specifically. Each configuration of the third embodiment is same as each configuration of the first embodiment except for functions, therefore the same reference characters as the first embodiment will be used in the explanation. FIG. 9 is a plane view explaining setting of the range of the use area according to the third embodiment, in a case where the object exists.

If the judgement portion 50 judges that the object OB exists in the judgement area JA, the judgement portion 50 calculates the position of the object OB in a similar manner to the second embodiment. Then, the judgement portion 50 generates the judgement information indicating the existence of the object OB and the position of the object OB, and then outputs the judgement information to the generation portion 52. The position of the object OB mentioned here may be a position of each portion of the outline of the object OB.

The generation portion 52 calculates the blind spot in the overlap area OA on the basis of the position of the object OB and sets the range of the use area EA in accordance with the blind spot, and generates the surrounding image. Specifically, the generation portion 52 calculates two tangents Tg which pass through the imaging portion 14, which are in contact with the outline of the object OB, and which serve as the boundaries of the blind spot. The generation portion 52 calculates a portion of a region surrounded by the two tangents Tg, the portion which is positioned farther than the object OB when viewed from the imaging portion 14, as the blind spot. On the basis of the calculated blind spot, the generation portion 52 sets the range of each use area EA in such a manner that the blind spot is not included in the overlap area OA in which the blind spot occurs. In the example illustrated in FIG. 9, the generation portion 52 sets a portion of the overlap area OA1 of the imaging portion 14c in which the blind spot occurs, the portion which is located at a side of the center line of the captured area PAc (that is, at an optical axis side of the imaging portion 14c) relative to the blind spot, as the range of the use area EAc12 of the imaging portion 14c. And the generation portion 52 sets another portion of the overlap area OA1, the portion which is positioned at a side of the center line of the imaging area PAa (that is, at an optical axis side of the imaging portion 14a) relative to the blind spot, and the blind spot, as the range of the use area EAa12 of the imaging portion 14a to which the blind spot is not generated.

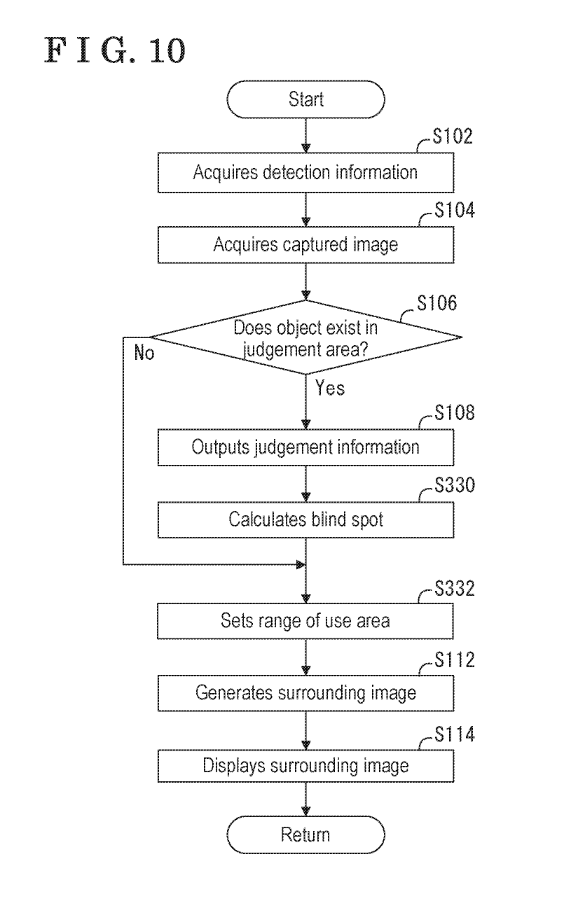

FIG. 10 is a flowchart of the surroundings monitoring processing according to the third embodiment performed by the processing portion 46. In the explanation of the third embodiment, the steps similar to the aforementioned embodiments will be explained in a simplified manner.

As illustrated in FIG. 10, according to the surroundings monitoring processing of the third embodiment, the judgement portion 50 and the generation portion 52 perform from Step S102 to Step S108.

The generation portion 52 calculates the blind spot on the basis of the judgement information (S330). Specifically, the generation portion 52 calculates the two tangents Tg each being in contact with the outline of the object OB. The generation portion 52 calculates a portion of the region surrounded by the two tangents Tg, the portion which is farther than the object OB, as the blind spot.

The generation portion 52 sets the range of the use area EA (S332). Specifically, in the overlap area OA in which the object OB does not exist in the judgment area JA, the generation portion 52 sets the range of the use area EA in such a manner that each of the overlap areas OA is bisected similarly to the range of the first use area EA of the first embodiment. In contrast, in the overlap area OA in which the blind spot occurs due to the object OB existing in the judgment area JA, the generation portion 52 sets the judgement area JA such that the blind spot is not included in the overlap area OA. For example, the generation portion 52 sets a portion of the overlap area OA of one imaging portion 14 to which the blind spot is generated, the portion which is located at a side of the center line of the imaging area PA of the one imaging portion 14 relative to the blind spot, as the range of the use area EA of the one imaging portion 14. The generation portion 52 sets the rest of the overlap area OA as the range of the use area EA of another imaging portion 14 (imaging portion 14 that shares the overlap area OA with the one imaging portion 14) to which the blind spot is not generated.

The generation portion 52 generates the surrounding image on the basis of the range of the use area EA that is set (S112). The generation portion 52 causes the generated surrounding image to be displayed at the display portion 40 (S114).

As stated above, the surroundings monitoring apparatus 34 of the third embodiment calculates the blind spot in the overlap area OA, and sets the range of the use area EA, which is according to the blind spot, in the overlap area OA. Thus, the surroundings monitoring apparatus 34 can reduce the blind spot from the surrounding image even more appropriately.

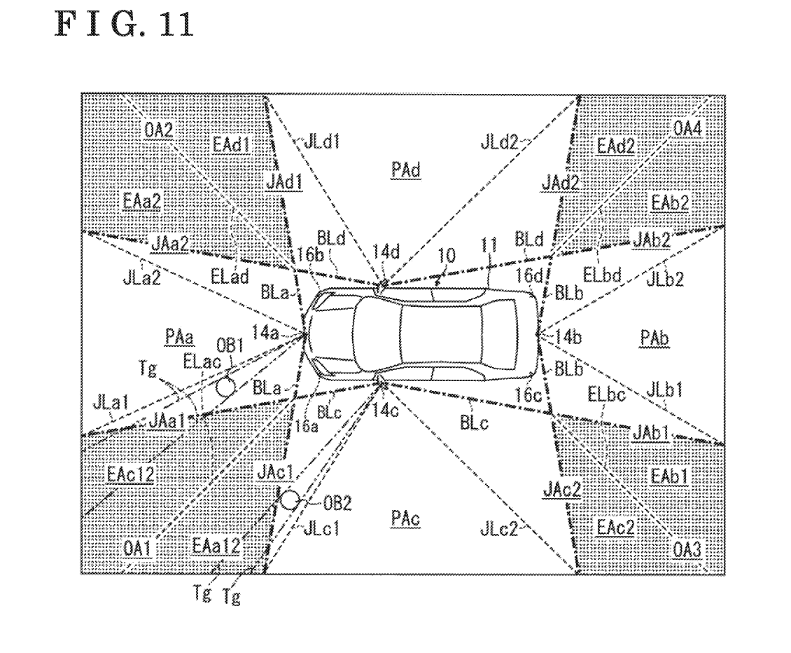

(Fourth embodiment) In a case where plural blind spots are generated in one overlap area OA, the surroundings monitoring apparatus 34 according to a fourth embodiment sets the ranges of the use areas EA in accordance with the blind spots. Configurations of the surroundings monitoring apparatus 34 of the fourth embodiment will be described below specifically. Each configuration of the fourth embodiment is same as each configuration of the first embodiment except for functions, therefore the same reference characters as the first embodiment will be used in the explanation. FIG. 11 is a plane view explaining setting of the range of the use area according to the fourth embodiment in a case where the objects exist.

If the judgement portion 50 judges that plural objects OB1 and OB2 exist in the judgement area JA, the judgement portion 50 calculates a position of each of the objects OB1 and OB2 in a similar manner to the second embodiment. The judgement portion 50 generates the judgement information indicating the existence of the objects OB1 and OB2 and the positions of the objects OB1 and OB2, and outputs the judgement information to the generation portion 52.

Upon obtaining the positions of the objects OB1 and OB2, the generation portion 52 calculates the two tangents Tg for each of the objects OB1 and OB2. The calculated tangents Tg pass through the imaging portion 14, are in contact with the outline of the corresponding object OB1, OB2, and serve as the boundary of the blind spot. For each of the objects OB1 and OB2, the generation portion 52 calculates, as the blind spot, a portion of a region surrounded by the two tangents Tg, the portion which is positioned farther than the object when viewed from the imaging portion 14. On the basis of the calculated blind spots, the generation portion 52 sets the range of each use area EA in such a manner that the blind spots are not included in the overlap area OA in which the blind spots occur. Specifically, the generation portion 52 sets the range of the use area EA as follows. The plural imaging portions 14 include one imaging portion 14 and another imaging portion 14 which is adjacent to the one imaging portion 14. In a case where the blind spot of the one imaging portion 14 exists in the overlap area OA of the one imaging portion 14 and the aforementioned another imaging portion 14, the generation portion 52 sets the range of the use area EA where the captured image taken by the aforementioned another imaging portion 14 is used in such a manner that the use area EA is set in a range corresponding to the blind spot in the overlap area OA. In a case where the blind spots exist in the overlap area OA1 of the imaging portion 14a and the imaging portion 14c as illustrated in FIG. 11, in the range corresponding to the blind spot of the imaging portion 14a, the generation portion 52 sets the range of the use area EAc12 where the captured image of the adjacent imaging portion 14c is used. In the range corresponding to the blind spot of the imaging portion 14c, the generation portion 52 sets the range of the use area EAa12 where the captured image of the adjacent imaging portion 14a is used. For example, the generation portion 52 may set the range of the use area EA by switching the range of the first use area EA in one overlap area OA in the first embodiment.

The flow of the surroundings monitoring processing of the fourth embodiment is similar to the third embodiment, and therefore the explanation will be omitted.

As stated above, at the surroundings monitoring apparatus 34 according to the fourth embodiment, in the position of the blind spot of one imaging portion 14 in the overlap area OA, the generation portion 52 sets the range of the use area EA in such a manner that the captured image of another imaging portion 14 which is adjacent to the one image portion 14 is used. Thus, even in a case where the plural bind spots occur in one overlap area OA, the surrounding image in which the blind spots are reduced can be generated.

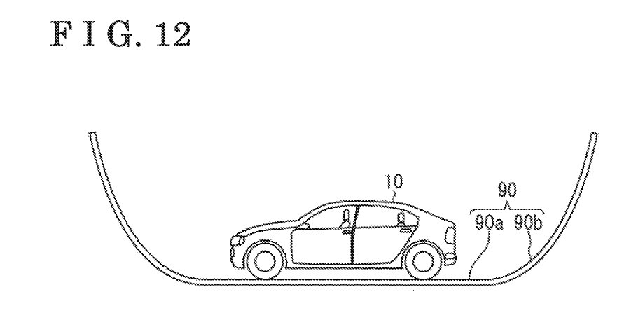

(Fifth embodiment) Next, a firth embodiment, which is another method of generating the surrounding image, will be described. FIG. 12 is a side view of a virtual space for explaining a method of generating the surrounding image according to the fifth embodiment.

The generation portion 52 may project the captured image on a virtual projection surface 90 which is in the virtual space and includes a shape of a bowl as illustrated in FIG. 12, and may generate, as the surrounding image, overhead image seen from a virtual view point above the vehicle 10. The virtual projection surface 90 includes a plane surface 90a at a central portion of the virtual projection surface 90, and a curved surface 90b which is arranged to surround a circumferential portion or a periphery of the plane surface 90a and is formed to open wider or expanded towards the upper side. Because the object OB projected on the virtual projection surface 90 including the shape of the bowl is indicated in the surrounding image in an extended or stretched manner, the blind spot becomes large. However, the generation portion 52 can reduce the blind spot by performing the processing described in the aforementioned embodiments.

For example, the functions, the relations of connection, the number, and/or the arrangements of the configurations of the aforementioned embodiments may be appropriately changed and/or omitted within the range of the disclosure and within the range of equivalents to the range of the disclosure. The embodiments may be combined with each other or one another appropriately. The order of the steps of each of the embodiments may be appropriately changed.

For example, the number and the arrangement of the imaging portions 14 described above may be changed appropriately. An angle of view of the imaging portion 14 in the horizontal direction may be changed appropriately.

According to the aforementioned embodiments, the judgement portion 50 detects the existence of the object OB on the basis of the detection information acquired from the distance measurement portion 16 and calculates the position of the object OB, however, the method of detecting the existence of the object OB and the method of calculating the position of the object OB are not limited to the aforementioned embodiments. For example, the judgement portion 50 may judge the existence of the object OB and calculate the position of the object OB, on the basis of the captured image. In this case, the generation portion 52 may set the range of the use area such that the object OB captured in the captured image does not appear or is not included in the surrounding image, and generate the surrounding image. In other words, the generation portion 52 uses or employs captured image in which the object OB is not captured or imaged, and generates the surrounding image.

In a case where the aforementioned embodiments are combined with each other, the processing portion 46 may switch the setting according to a mode received from an occupant including the driver. For example, when the processing portion 46 receives the setting of a first mode from the occupant, the processing portion 46 may generate the surrounding image with the setting of the first embodiment. When receiving the setting of a second mode from the occupant, the processing portion 46 may generate the surrounding image with the setting of the second embodiment or the setting of the third embodiment.

In the aforementioned embodiments, the explanations are made for a case where the mobile body is the four-wheel vehicle 10, however, the mobile body is not limited to the vehicle 10. The mobile body may be an apparatus provided with a drive source, for example, the mobile body may be a vehicle including two or more wheels, a vessel or ship, and an airplane or aircraft.

According to the aforementioned embodiment, a surroundings monitoring apparatus 34 includes a judgement portion 50 configured to judge an object OB, OB1, OB2 in a judgement area JA, JAa1, JAa2, JAb1, JAb2, JAc1, JAc2, JAd1, JAd2 set in surroundings of a vehicle 10 (i.e., a mobile body) provided with plural imaging portions 14, 14a, 14b, 14c, 14d each including an imaging area PA, PAa, PAb, PAc, PAd. In an overlap area OA, OA1, OA2, OA3, OA4 in which the imaging areas PA, PAa, PAb, PAc, PAd of the plural imaging portions 14, 14a, 14b, 14c, 14d overlap each other, a generation portion 52 is configured to set a range of a use area EA, EAa1, EAc1, EAa2, EAd1, EAb1, EAc2, EAb2, EAd2, EAa12, EAc12 in which captured image captured at the imaging portions 14, 14a, 14b, 14c, 14d is used, and the generation portion 52 is configured to generate surrounding image of the vehicle 10, the surrounding image includes the captured image used in the use area EA, EAa1, EAc1, EAa2, EAd1, EAb1, EAc2, EAb2, EAd2, EAa12, EAc12. The generation portion 52 changes the range of the use area EA, EAa1, EAc1, EAa2, EAd1, EAb1, EAc2, EAb2, EAd2, EAa12, EAc12 and generates the surrounding image in accordance with the object OB, OB1, 062.

According to the above-described configuration, the surroundings monitoring apparatus 34 judges whether or not the object OB, OB1, OB2, which causes a blind spot, exists in the judgement area JA, JAa1, JAa2, JAb1, JAb2, JAc1, JAc2, JAd1, JAd2. The surroundings monitoring apparatus 34 sets, in accordance with the object OB, OB1, OB2, the range of the use area EA, EAa1, EAc1, EAa2, EAd1, EAb1, EAc2, EAb2, EAd2, EAa12, EAc12 that is for using either of the captured images overlapping each other in the overlap area OA, OA1, OA2, OA3, OA4. Thus, in the overlap area OA, OA1, OA2, OA3, OA4, the surroundings monitoring apparatus 34 uses the captured image including less blind spot, and can provide the surrounding image in which the blind spot is reduced.

According to the aforementioned embodiment, the generation portion 52 sets a range of a first use area EA, EAa1, EAc1, EAa2, EAd1, EAb1, EAc2, EAb2, EAd2 in the overlap area OA, OA1, OA2, OA3, OA4 in a case where the object OB, OB1, OB2 does not exist in the judgement area JA, JAa1, JAa2, JAb1, JAb2, JAc1, JAc2, JAd1, JAd2 and the generation portion 52 sets a range of a second use area EA, EAa12, EAc12 in the overlap area OA, OA1, OA2, OA3, OA4 in a case where the object OB, OB1, OB2 exists in the judgement area JA, JAa1, JAa2, JAb1, JAb2, JAc1, JAc2, JAd1, JAd2, the range of the first use area EA, EAa1, EAc1, EAa2, EAd1, EAb1, EAc2, EAb2, EAd2 and the range of the second use area EA, EAa12, EAc12 are determined in advance, and the generation portion 52 generates the surrounding image.

According to the above-described configuration, the surroundings monitoring apparatus 34 sets either of the predetermined range of the first use area or the predetermined range of the second use area depending on whether or not the object OB, OB1, OB2 exists. Thus, the surroundings monitoring apparatus 34 can provide the surrounding image in which the blind spot is reduced, while reducing the burden of the processing needed to set the range of the use area EA, EAa1, EAc1, EAa2, EAd1, EAb1, EAc2, EAb2, EAd2.

According to the aforementioned embodiment, the judgement portion 50 is configured to calculate a position of the object OB, OB1, OB2 in the judgement area JA, JAa1, JAa2, JAb1, JAb2, JAc1, JAc2, JAd1, JAd2, and the generation portion 52 is configured to set the range of the use area EA, EAa1, EAc1, EAa2, EAd1, EAb1, EAc2, EAb2, EAd2, EAa12, EAc12 in accordance with the position of the object OB, OB1, OB2 and generate the surrounding image.

According to the above-described configuration, the surroundings monitoring apparatus 34 sets the range of the use area EA, EAa1, EAc1, EAa2, EAd1, EAb1, EAc2, EAb2, EAd2, EAa12, EAc12 that is in accordance with the position of the object OB, OB1, OB2 existing in the judgement area JA, JAa1, JAa2, JAb1, JAb2, JAc1, JAc2, JAd1, JAd2. Thus, out of the captured images, the surroundings monitoring apparatus 34 can reduce the use or employment of the captured image of the vicinity of the outer edge portion of the image area PA, PAa, PAb, PAc, PAd in which the image distortion is large. As a result, the surroundings monitoring apparatus 34 can provide the surrounding image including a high image quality and reduced blind spot.

According to the aforementioned embodiment, the generation portion 52 is configured to calculate a blind spot in the overlap area OA, OA1, OA2, OA3, OA4 on the basis of the position of the object OB, OB1, OB2, set the range of the use area EA, EAa12, EAc12 in accordance with the blind spot, and generate the surrounding image.

According to the above-described configuration, the surroundings monitoring apparatus 34 calculates the blind spot existing in the overlap area OA, OA1, OA2, OA3, OA4, and sets, in the overlap area OA, OA1, OA2, OA3, OA4, the range of the use area EA, EAa12, EAc12 that is in accordance with the blind spot. Thus, the surroundings monitoring apparatus 34 can appropriately reduce the blind spot from the surrounding image.

According to the aforementioned embodiment, the plural imaging portions 14, 14a, 14b, 14c, 14d include one imaging portion 14, 14a, 14b, 14c, 14d and another imaging portion 14, 14a, 14b, 14c, 14d which is adjacent to the one imaging portion 14, 14a, 14b, 14c, 14d. In a case where the blind spot of the one imaging portion 14, 14a, 14b, 14c, 14d exists in the overlap area OA, OA1, OA2, OA3, OA4, the generation portion 52 sets the range of the use area EA, EAa12, EAc12 in which the captured image of said another imaging portion 14, 14a, 14b, 14c, 14d is used in such a manner that the range of the use area EA, EAa12, EAc12 is set in a range corresponding to the blind spot in the overlap area OA, OA1, OA2, OA3, OA4.

According to the above-described configuration, in the overlap area OA, OA1, OA2, OA3, OA4, the surroundings monitoring apparatus 34 sets the range of the use area EA, EAa12, EAc12 in such a manner that the captured image of the aforementioned another imaging portion 14, 14a, 14b, 14c, 14d adjacent to the one imaging portion 14, 14a, 14b, 14c, 14d is used at the position of the blind spot of the one imaging portion 14, 14a, 14b, 14c, 14d. Thus, even in a case where the plural blind spots occur in one of the overlap area OA, OA1, OA2, OA3, OA4, the surrounding image including the reduced blind spot can be generated.

According to the aforementioned embodiment, the generation portion 52 is configured to project the captured image on a virtual projection surface 90 which is in a virtual space and includes a shape of a bowl, and the generation portion 52 is configured to generate, as the surrounding image, overhead image seen from a virtual view point.

According to the above-described configuration, the captured image in which the object OB, OB1, OB2 is not captured or imaged is used, and thus the blind spot can be reduced.

The principles, preferred embodiments and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A surroundings monitoring apparatus, comprising:
a judgement portion configured to judge an object in a judgement area set in surroundings of a mobile body, the mobile body being provided with a plurality of imaging portions each including an imaging area; and
in an overlap area in which the imaging areas of the plurality of imaging portions overlap each other, a generation portion configured to set a range of a use area in which captured image captured at the imaging portions is used, and the generation portion configured to generate surrounding image of the mobile body, the surrounding image including the captured image used in the use area, wherein
the generation portion changes the range of the use area and generates the surrounding image in accordance with the object.

2. The surroundings monitoring apparatus according to claim 1, wherein
the generation portion sets a range of a first use area in the overlap area in a case where the object does not exist in the judgement area and the generation portion sets a range of a second use area in the overlap area in a case where the object exists in the judgement area, the range of the first use area and the range of the second use area are determined in advance, and
the generation portion generates the surrounding image.

3. The surroundings monitoring apparatus according to claim 1, wherein
the judgement portion is configured to calculate a position of the object in the judgement area, and
the generation portion is configured to set the range of the use area in accordance with the position of the object and generate the surrounding image.

4. The surroundings monitoring apparatus according to claim 2,
the judgement portion is configured to calculate a position of the object in the judgement area, and
the generation portion is configured to set the range of the use area in accordance with the position of the object and generate the surrounding image.

5. The surroundings monitoring apparatus according to claim 3, wherein the generation portion is configured to calculate a blind spot in the overlap area on the basis of the position of the object, set the range of the use area in accordance with the blind spot, and generate the surrounding image.

6. The surroundings monitoring apparatus according to claim 4, wherein the generation portion is configured to calculate a blind spot in the overlap area on the basis of the position of the object, set the range of the use area in accordance with the blind spot, and generate the surrounding image.

7. The surroundings monitoring apparatus according to claim 5, wherein
the plurality of imaging portions includes one imaging portion and another imaging portion which is adjacent to the one imaging portion, and
in a case where the blind spot of the one imaging portion exists in the overlap area, the generation portion sets the range of the use area in which the captured image of said another imaging portion is used in such a manner that the range of the use area is set in a range corresponding to the blind spot in the overlap area.

8. The surroundings monitoring apparatus according to claim 6, wherein
the plurality of imaging portions includes one imaging portion and another imaging portion which is adjacent to the one imaging portion, and
in a case where the blind spot of the one imaging portion exists in the overlap area, the generation portion sets the range of the use area in which the captured image of said another imaging portion is used in such a manner that the range of the use area is set in a range corresponding to the blind spot in the overlap area.

9. The surroundings monitoring apparatus according to claim 3, wherein
the generation portion is configured to project the captured image on a virtual projection surface which is in a virtual space and includes a shape of a bowl, and
the generation portion is configured to generate, as the surrounding image, overhead image seen from a virtual view point.
